(19) United States
(12) Patent Application Publication
(10) Pub. No.: US 2011/0062848 A1
(43) Pub. Date: Mar. 17, 2011

(54) LED LAMP ELECTRODE STRUCTURE

(76) Inventors: Kun-Jung Chang, Kaohsiung County (TW); Ching-Yuan Juan, Kaohsiung County (TW); Kuo-Chun Lin, Kaohsiung County (TW); Ching-Huang Juan, Kaohsiung County (TW)

(21) Appl. No.: 12/558,228

(22) Filed: Sep. 11, 2009

(51) Int. Cl. H01J 5/48

(52) U.S. Cl. 313/49

(57) ABSTRACT

An LED lamp electrode structure includes a jutting coupling portion at a lower side of an LED lamp and two electrode passages corresponding to and communicating with LED chip electrodes. The electrode passages are filled with silver paste or hold electric wires to establish electric connection with the chip electrodes. Thus wiring can be concealed and aesthetic appealing improves, and safety and practicality are enhanced.

### FIELD OF THE INVENTION

The present invention relates to an LED lamp electrode structure, and more particularly to provide improved connection of LED lamp electrodes.

### BACKGROUND OF THE INVENTION

Conventional LED lamps 1a and 1b, referring to FIG. 1, have LED chips 11a and 11b with a heat conduction element 20a at the bottom and electrodes 12a and 12b located at outer sides of the LED lamps 1a and 1b. When in use for illumination, the LED lamps 1a and 1b emit light and heat is conducted through the heat conduction element 20a at the bottom to lower the temperature of the LED lamps 1a and 1b.

To facilitate wiring and replacing of the LED lamps 1a and 1b, they are made in a modular fashion and have the wiring formed on a printed circuit board (PCB) 3a with the heat conduction element 20a mounted thereon. Then the LED lamps 1a and 1b are soldered on the PCB 3a to become a module. Such a module has drawbacks, notably:

1. The LED lamps cannot be replaced individually on the LED lamp module, resource waste incurs.

2. The PCB is formed in a fixed shape, direction and arrangement, and does not allow the LED lamps to be flexibly deployed thereon.

3. The wiring is exposed to the PCB. It is not aesthetic appealing and has safety concern in terms of electric power utilization.

### SUMMARY OF THE INVENTION

The primary object of the present invention is to solve the disadvantages of the conventional LED lamps that have electrodes located at two sides making deploying of the LED lamps inflexible and having exposed wiring to the PCB that result in use difficulty and safety concern.

To achieve the foregoing object, the present invention provide an improved LED lamp electrode structure with a single LED lamp as a module and electrodes moved from two sides of the LED lamp to the bottom thereof so that they can be directly connected to an electric wire or power supply without a PCB to allow the LED lamp module to emit light. The LED lamp also can be replaced individually.

The present invention is based on another invention of the inventor at U.S. application Ser. No. 11/907,279 incorporated with novel techniques, including repositioning LED chip electrodes, adding two electrode passages running through a jutting coupling portion at the bottom of an LED lamp, filling the electrode passages with a conductive medium such as silver paste or connecting electric wires to form electrodes to establish electric connection with the LED chip electrodes. By altering the positions of the LED lamp electrodes, installation and replacement of the LED lamp are simpler and easier.

By means of the construction set forth above, the present invention provides many benefits, notably:

1. The electrodes are concealed at the bottom of the jutting coupling portion and wiring is hidden. It is safer and more aesthetic appealing.

2. With the lamp electrodes concealed at the bottom of the jutting coupling portion, the PCB can be dispensed with. The LED lamp can be deployed and arranged more flexibly.

3. The LED module can be shrunk to become a single LED lamp, and can be replaced individually and still maintain the convenience of modular structure.

4. The LED lamp can be mounted onto a seat or heat conduction element at varying angles according to requirements to generate desired lighting styles and illumination.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional LED lamp electrode structure.

FIG. 2 is a top perspective view of the jutting coupling portion according to the invention.

FIG. 3 is a bottom perspective view of the jutting coupling portion according to the invention.

FIG. 4 is a sectional view of the jutting coupling portion according to the invention showing electrode passages.

FIG. 5 is a sectional view of the jutting coupling portion according to the invention screwed on a heat conduction seat and a PCB.

FIG. 6 is a schematic view of the invention mounted onto the heat conduction seat and the PCB.

FIG. 7 is a perspective view of the invention mounted onto the heat conduction seat and the PCB.

FIG. 8 is a sectional view of an embodiment of the invention showing a slanted electrode passage formed in the jutting coupling portion.

FIG. 9 is a perspective view of another embodiment of the invention with soldered electric wires.

FIG. 10 is a perspective view of yet another embodiment of the invention with a T-shaped track and a T-shaped trough.

FIG. 11 is a perspective view of yet another embodiment of the invention with the T-shaped track wedged in the T-shaped trough.

FIG. 12 is a perspective view of still another embodiment of the invention with a conductive clip formed on the jutting coupling portion.

FIG. 13 is a sectional view of still another embodiment of the invention with the conductive clip formed on the jutting coupling portion.

FIG. 14 is a perspective view of another embodiment of the invention mounted onto an arched heat sink.

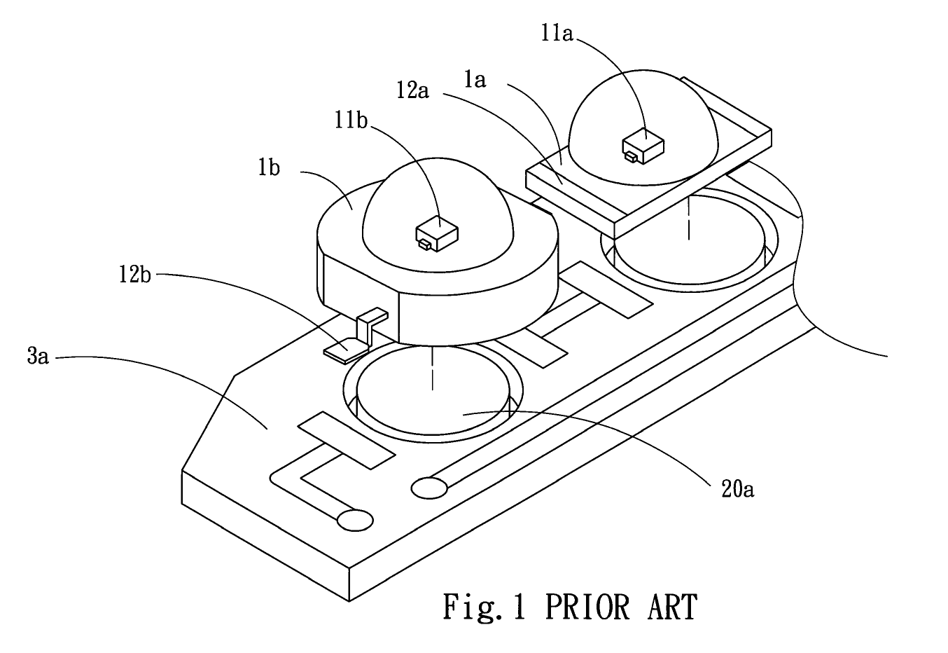

### DETAILED DESCRIPTION OF THE PREFERRED EMBODIMENTS

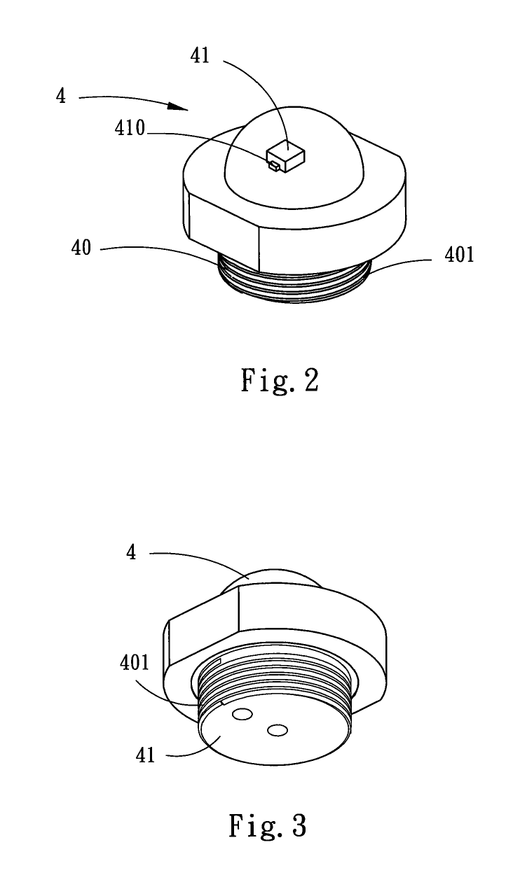

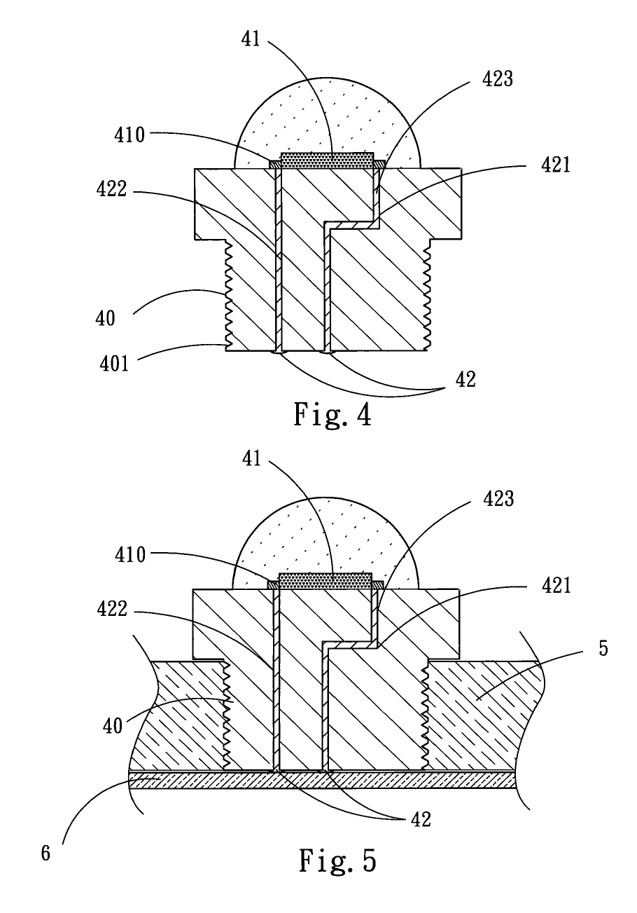

Please refer to FIGS. 2 through 5, the LED lamp electrode structure according to the invention mainly includes an LED lamp 4 that has an LED chip 41 inside with two chip electrodes 410 and a jutting coupling portion 40 at the bottom. The jutting coupling portion 40 has screw threads 401 on the periphery and two electrode passages 421 and 422 communicating with the chip electrodes 410. One electrode passage 421 is tortuous and has an opening in the center of the bottom of the jutting coupling portion 40, and the other electrode passage 422 has another opening close to the outer edge of the bottom of the jutting coupling portion 40. The electrode passages 421 and 422 are filled with a conductive medium 423 such as silver paste so that the openings of the electrode passages 421 and 422 form two lamp electrodes 42 to electrically connect with the chip electrodes 410.

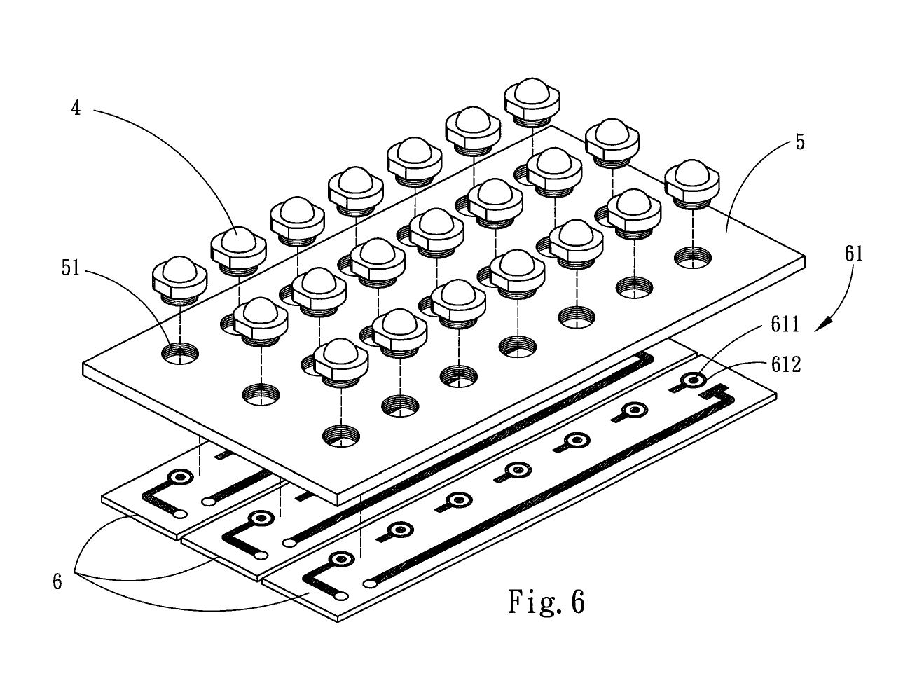

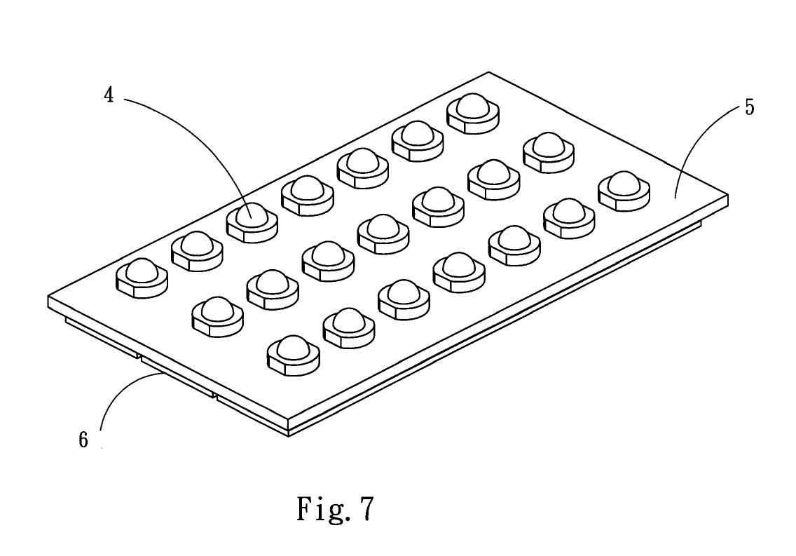

Referring to FIGS. 5, 6 and 7, the jutting coupling portion 40 of the LED lamp 4 can be fastened to a tapped heat conduction seat 5 with an aperture 51 formed thereon. The heat conduction seat 5 has a PCB 6 located at the bottom. The PCB 6 has a plurality of power supply elements 61 each has a contact 611 in the center and a power supply ring 612 located around the contact 611. When the LED lamp 4 is screwed on the heat conduction seat 5 and mounted onto the PCB 6, the lamp electrode 42 in the center of the LED lamp 4 is connected to the contact 611 and the other lamp electrode 42 located at the outer edge is connected to the power supply ring 612 so that the LED lamp 4 is energized to emit light.

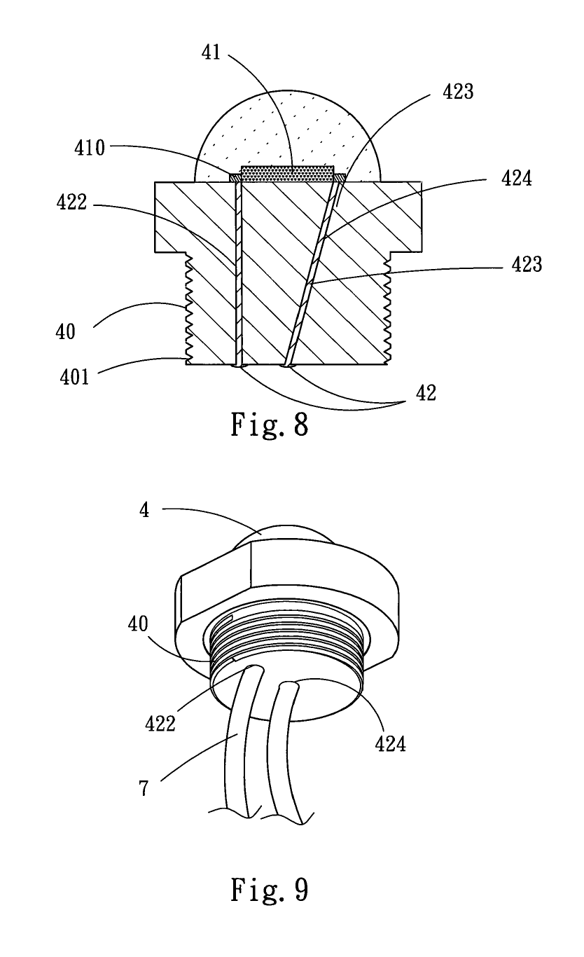

Referring to FIG. 8, a slanted electrode passage 424 may also be formed in the LED lamp 4 with the opening in the center at the bottom of the jutting coupling portion 40 while the other electrode passage 422 has the opening close to the outer edge at the bottom. The two electrode passages 424 and 422 also are filled with the conductive medium 423 such as silver paste to form the lamp electrodes 42 at the openings to electrically connect with the two chip electrodes 410 as previously discussed.

Refer to FIG. 9 for another embodiment of the invention. Electric wires 7 are provided and inserted into the electrode passages 422 and 424 from the bottom of the jutting coupling portion 40 to the LED lamp 4 soldered to form electric connection.

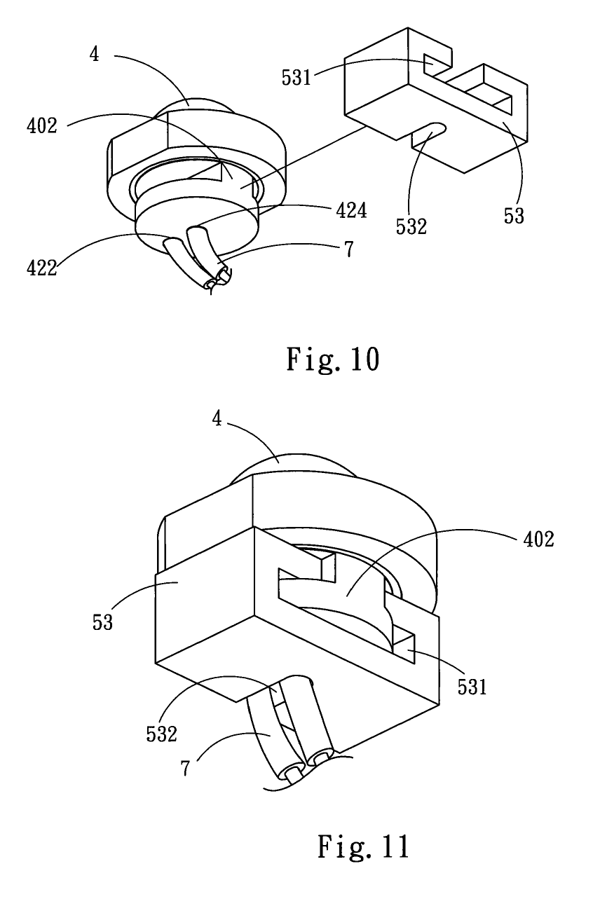

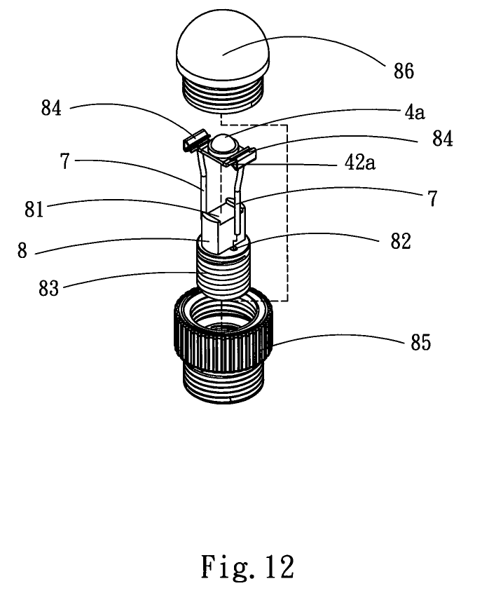

Refer to FIGS. 10 and 11 for yet another embodiment of the invention. A T-shaped track 402 is provided at the bottom of the LED lamp 4 with the electrode passages 422 and 424 formed thereon to receive the electric wires 7 to electrically connect with the LED lamp 4 for lighting. The T-shaped track 402 is wedged in a T-shaped trough 531 formed on a heat conduction trough 53. The heat conduction trough 53 has a notch 532 at the bottom to allow the electric wires 7 to run through the heat conduction trough 53.

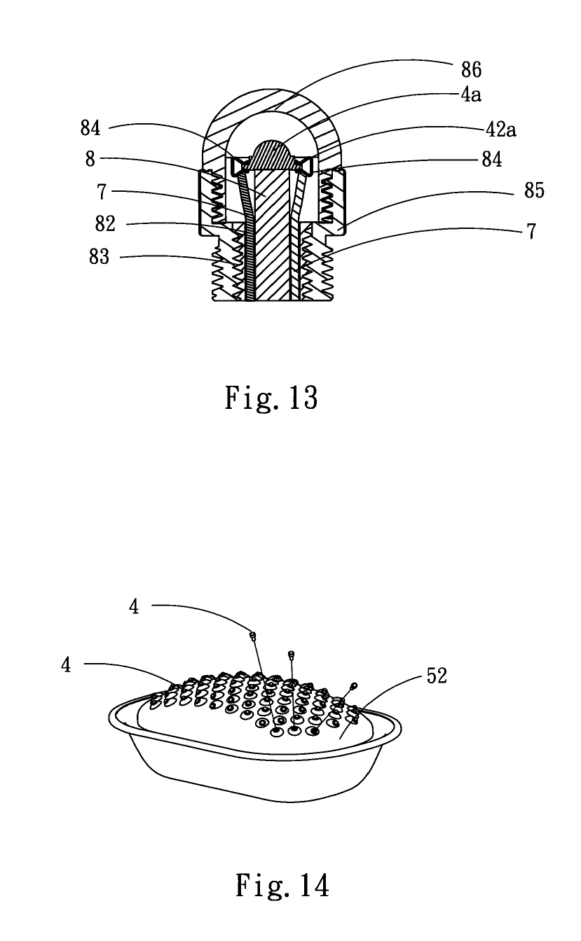

Refer to FIGS. 12 and 13 for still another embodiment of the invention. It has a jutting coupling portion 8 with a conductive clip 84 located thereabove and a fastening portion 81 located thereon to fasten an LED lamp 4a. The LED lamp 4a has lamp electrodes 42a at two sides and electrode passages 82 beneath the lamp electrodes 42a with openings formed at the bottom of the jutting coupling portion 8 close to the outer edge thereof. The jutting coupling portion 8 has screw threads 83 formed at a lower side on the periphery. A set of conductive clips 84 are elastic to clip the lamp electrodes 42a at the two sides of the LED lamp 4a. A set of electric wires 7 run through the electrode passages 82 to be soldered on lower sides of the conductive clips 84 to establish electric connection among the electric wires 7, conductive clips 84 and lamp electrodes 42a. Finally, the jutting coupling portion 81 is screwed into a socket 85, and a lamp shade 86 can be coupled or screwed on the socket 85.

Refer to FIG. 14 for another embodiment of the invention. LED lamps 4 are mounted onto an arched surface of an arched heat sink 52 which can conceal wiring. The LED lamps 4 can be positioned at varying angles in different directions by means of the arched heat sink 52 to meet special illumination requirements.

What is claimed is:

1. An LED lamp electrode structure comprising an LED lamp which has an LED chip attached to two chip electrodes and a jutting coupling portion at the bottom, and two electrode passages communicating with the chip electrodes, the electrode passages being filled with a conductive medium to form lamp electrodes to establish electric connection with the chip electrodes.

2. The LED lamp electrode structure of claim 1, wherein one of the electrode passages is tortuous.

3. The LED lamp electrode structure of claim 1, wherein one of the electrode passages is formed in a slanted manner.

4. The LED lamp electrode structure of claim 1, wherein the jutting coupling portion has screw threads formed on the periphery.

5. The LED lamp electrode structure of claim 1, wherein the jutting coupling portion is a T-shaped track.

6. The LED lamp electrode structure of claim 1, wherein the conductive medium is an electric wire.

7. An LED lamp electrode structure comprising an LED lamp which has electrodes at two sides and a jutting coupling portion at the bottom, two electrode passages formed in the jutting coupling portion corresponding to and below the electrodes, a set of elastic conductive clips clipping the electrodes at the two sides and a set of electric wires running through the electrode passages and being soldered on the conductive clips to form electric connection with the electrodes.

8. The LED lamp electrode structure of claim 7, wherein the jutting coupling portion has a fastening portion at the top to fasten the LED lamp.

9. The LED lamp electrode structure of claim 7, wherein the jutting coupling portion has screw threads formed on the periphery at a lower side thereof.
